(19) United States
(12) Patent Application Publication
(10) Pub. No.: US 2003/0033219 A1
(43) Pub. Date: Feb. 13, 2003

(54) Method for supporting to select products and server for supporting to select products

(75) Inventors: Tomomi Kasahara, Kawasaki (JP); Megumi Yoshimura, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/100,995

(22) Filed: Mar. 20, 2002

(30) Foreign Application Priority Data
Aug. 10, 2001 (JP) 2001-244841

(51) Int. Cl. G06F 17/60

(52) U.S. Cl. 705/27

(57) ABSTRACT

In a method for supporting to select products suitable to the product user by using a computer, first image information of a possessed product possessed by the product user is obtained and second image information of a purchase desired product desired for purchase by a product purchaser is obtained. A result from comparing the first image information with the second image information is shown to the product purchaser.

### BACKGROUND OF THE INVENTION

1. Field of the Invention

The present invention generally relates to methods for supporting to select products, servers for supporting to select products, and computer-readable recording media having a program recorded thereon for causing a computer to support to select products, and more particularly to a method for supporting to select products, a server for supporting to select products, and a computer-readable recording medium having a program recorded thereon for causing a computer to support to select products, which support product users to select products by using a computer.

2. Description of the Related Art

For example, when a product user purchases a product of clothing, such as clothes and shoes, it is necessary to check whether or not the size of the product suits the product user. When a product purchaser and the product user are the same person, it can be checked by fitting whether or not the size of the product suits the product user.

On the other hand, when the product purchaser and the product user are not the same person and the product user is not available on that occasion, it cannot be checked by fitting whether or not the size of the product suits the product user.

Therefore, the product purchaser judges whether or not the size of the product would suit the product user by using a standard size (for example, size 7, size 9, size 23 cm, or size 24 cm), an image, or by personal tastes for a product.

Moreover, Japanese Laid-Open Patent Application No.11-265243 discloses a virtual fitting method in which when purchasing clothes in electronic commerce, measurement data of a part of a body of the purchaser, which are registered beforehand, are compared with the size of the product, and then, the purchaser is notified of the comparison result showing a fit state.

However, the standard size of the product has variation in form or size depending upon the maker (manufacturer) or the brand. Therefore, there is a problem in that the standard size of the product is only used for an approximate reference.

Furthermore, in the virtual fitting method disclosed by Japanese Laid-Open Patent Application No.11-265243, since the measurement data of the part of the body of the product purchaser are compared with the size of a product, it is required to register the measurement data of the part of the body of the product purchaser beforehand.

Moreover, judgment criteria for judging whether or not the size of the product fits the product user is changed depending on the product user or the type of the product. It cannot judge simply only by comparing the measurement data of the part of the body of the product purchaser with the size of the product.

### SUMMARY OF THE INVENTION

It is a general object of the present invention to provide a method for supporting to select products, a server for supporting to select products, and a computer-readable recording medium having a program recorded thereon for causing a computer to support to select products, which support product users to select products by using a computer in which the above-mentioned problems are eliminated.

A more specific object of the present invention is to provide a method for supporting to select products, a server for supporting to select products, and a computer-readable recording medium having a program recorded thereon for causing a computer to support to select products, which support product users to select products by using a computer, which display information of a possessed product which a product user possesses so as to contrast with a picture of a new product and can help to select the new product.

The above object of the present invention is achieved by a method for supporting to select products suitable to a product user by using a computer, including the steps of: (a) obtaining first image information of a possessed product possessed by the product user; (b) obtaining second image information of a purchase desired product desired for purchase by a product purchaser; and (c) showing a result from comparing the first image information with the second image information, to the product purchaser.

The possessed product is a product actually possessed by the product user, and also can indicate a preference of the product user. That is, a product similar to the possessed product can be recognized as a product corresponding to the preference of the product user. Therefore, since the result from comparing the first image information with the second image information is shown to the product purchaser, it is possible for the product purchaser to select the product suitable to the product user.

Moreover, since the product user or the product purchaser can intuitively and easily imagine the possessed product possessed by the product user, it is possible for the product purchaser to comfortably select the product suitable to the product user by referring to the result from comparing the first image information of the possessed product with the second image information of the purchase desired product.

Furthermore, since the first image information of the possessed product is utilized, it is possible for the product purchaser to select the product suitable to the product user while considering a combination of the possessed product and the purchase desired product.

### BRIEF DESCRIPTION OF THE DRAWINGS

Other objects, features, and advantages of the present invention will become more apparent from the following detailed description when read in conjunction with the accompanying drawings, in which:

FIG. 1 is a diagram showing a system example including a product selection supporting server according to an embodiment of the present invention;

FIG. 2 is a diagram showing a configuration of a product selection supporting server of FIG. 1;

FIG. 3 is a diagram showing a function included in the product selection supporting server of FIG. 1;

FIG. 4 is a diagram showing a configuration example of a customer detail master DB of FIG. 3;

FIG. 5 is a flowchart for explaining a process example conducted by a customer detail registering part of FIG. 3;

FIG. 6 is a diagram showing a configuration example of a customer master DB of FIG. 3;

FIG. 7 is a diagram showing a configuration example of a purchase-history-at-another-shop master DB of FIG. 3;

FIG. 8 is a flowchart for explaining a process example conducted by a purchase-history-at-another-shop registering part of FIG. 3;

FIG. 9 is a diagram showing a configuration example of a sales history master DB of FIG. 3;

FIG. 10 is a flowchart for explaining a process example conducted by a sales history registering part of FIG. 3;

FIG. 11 is a flowchart for explaining a process example conducted by a product purchaser/product user specifying part of FIG. 3;

FIG. 12 is a flowchart for explaining a process example conducted by a purchase desired product specifying part of FIG. 3;

FIG. 13 is a flowchart for explaining a process example conducted by a possessed product specifying part of FIG. 3;

FIG. 14 is a flowchart for explaining a process example conducted by a determined product specifying part of FIG. 3;

FIG. 15 is a flowchart for explaining a process example conducted by a coordinating part of FIG. 3;

FIG. 16 is a diagram showing a configuration example of a product master DB of FIG. 3;

FIG. 17 is a diagram showing an example of a product selection supporting window; and

FIG. 18 is a flowchart for explaining an example of a method for supporting to select products, according to the embodiment of the present invention.

### DESCRIPTION OF THE PREFERRED EMBODIMENTS

An embodiment according to the present invention will be described with reference to figures. In the embodiment, a method for supporting to select clothing as an example of a product will be described but any product can be applied to the method.

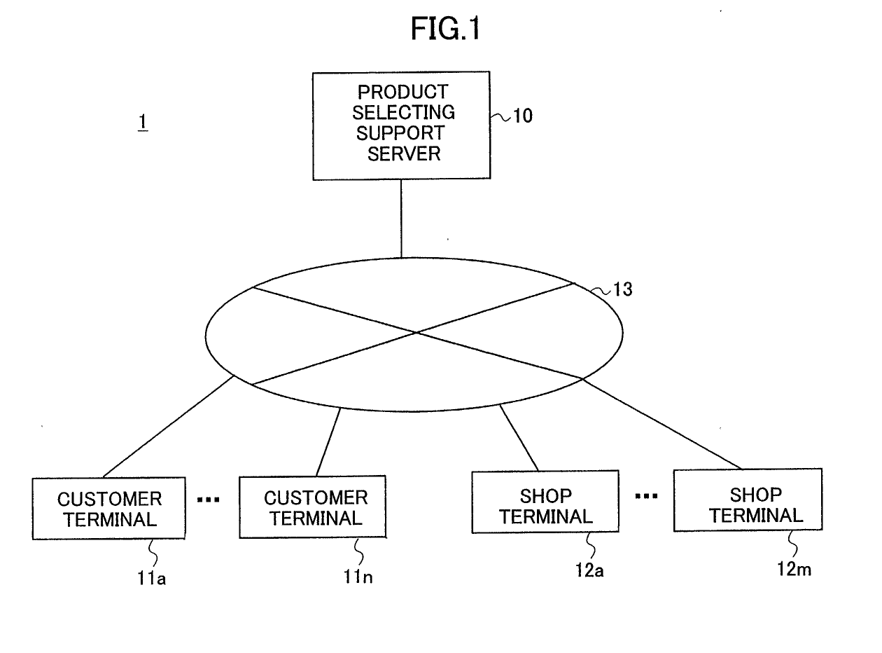

FIG. 1 is a diagram showing a system example including a product selection supporting server according to the embodiment of the present invention. In a system 1 in FIG. 1, a product selection supporting server 10, at least one of customer terminals 11a through 11n, and at least one of shop terminals 12a through 12m are connected to a network 13 such as the Internet.

In the system 1, the product selection supporting server 10 is connected to the customer terminals 11a through 11n and the shop terminals 12a through 12m via the same network 13. Alternatively, the customer terminals 11a through 11n and the shop terminals 12a through 12m can be connected to the product selection supporting server 10 via different networks (not shown).

The customer terminals 11a through 11n are operated by customers, and for example, are provided at homes of the customers. Each of the customer terminals 11a through 11n includes a function to communicate with the product selection supporting server 10 via the network 13. In the embodiment, each of a product purchaser and a product user is generally called a customer.

For example, each of the shop terminals 12a-12m is provided in each shop in the department store that sells a product. Each of the shop terminals 12a-12m includes a function for communicating with the product selection supporting server 10 through the network 13.

For example, when the network 13 is the Internet, the customer terminals 11a through 11n and the shop terminals 12a through 12m are terminals capable of connecting to the Internet, and include functions for browsing a Web page stored in the product selection supporting server 10.

For example, the product selection supporting server 10 is provided in a data center of a head office of the department store that manages shops in the department store. Alternatively, for example, the product selection supporting server 10 can be provided in a data center of a third party that received consignments from the head office of the department store.

Various information required in order to realize a method for supporting to select products according to the present invention is supplied from the customer terminals 11a through 11n and the shop terminals 12a through 12m to the product selection supporting server 10. The product selection supporting server 10 manages the various information inputs. Moreover, in response to requests from the customer terminals 11a through 11n and each of the shop terminals 12a through 12m, the product selection supporting server 10 conducts a process for supporting to select products and supplies a process result to each of the customer terminals 11a through 11n and each of the shop terminals 12a through 12m.

For example, in a case in which the network 13 is the Internet, the product selection supporting server 10 includes a function for sending a Web page to the customer terminals 11a through 11n and the shop terminals 12a through 11m.

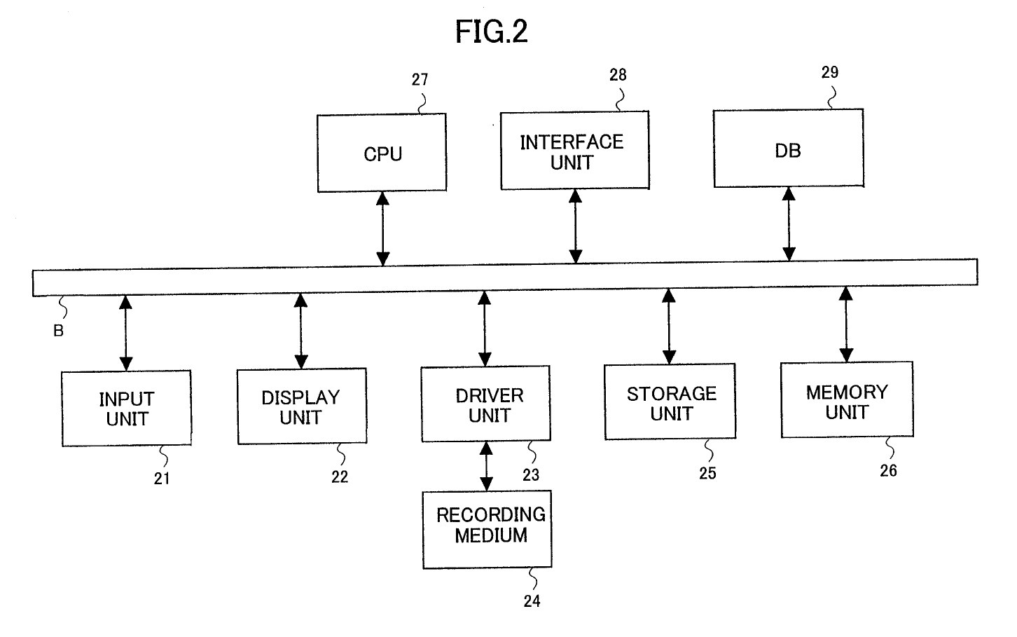

The product selection supporting server 10, for example, can be configured as shown in FIG. 2. FIG. 2 is a diagram showing a configuration of the product selection supporting server. The product selection supporting server 10 in FIG. 2 includes an input unit 21, a display unit 22, a driver unit 23, a recording medium 24, a storage memory 25, a memory unit 26, a CPU (Central Processing Unit) 27, an interface unit 28, and a database (hereinafter, called DB) 29, which are mutually connected by a bus B.

The input unit 21 includes a keyboard, a mouse, and the like, which a user as a manager of the product selection supporting server 10 operates, and the input unit 21 is used in order to input various operation signals into the product selection supporting server 10. The display unit 22 displays various windows, data, and the like that are needed to operate the product selection supporting server 10. The interface unit 28 is an interface for connecting the product selection supporting server 10 to the network 13, and for example, the interface unit 28 includes a modem, a router, and the like.

The DB 29 stores various information required in order to realize the method for supporting selection products, for example, a customer detail master DB, a customer master DB, a purchase-history-at-another-shop master DB, a sales history master DB, a product master DB, and the like. The customer detail master DB, the customer master DB, the purchase-history-at-another-shop master DB, the sales history master DB, and the product master DB will be described in detail later.

A program for supporting to select products that is used for the product selection supporting server 10 is provided by a recording medium 24 such as a CD-ROM, or the like. The recording medium 24 can be the CD-ROM (Compact Disc Read-Only Memory) but also a flexible disk, a magneto-optical disk (MO), or the like, which optically, electrically, or magnetically record information. Or the recording medium 24 can be a semiconductor memory such as a ROM (Read Only Memory), a flash memory, or the like, which electrically records information. Various types of recording media can be applied to the recording medium 24.

The recording medium 24 recording the program for supporting to select products is set in the driver unit 23 and the program for supporting to select products is installed in the storage unit 25.

The storage unit 25 stores the program for supporting to select products as well as necessary files, data, and the like. The memory unit 26 reads the program for supporting to select products from the storage unit 25 when the product selection supporting server 10 is executing, and then stores the program. The CPU 27 conducts a process for the product selection supporting server 10 in accordance with the program for supporting selection products that is read from the storage unit 25 and stored in the memory unit 26.

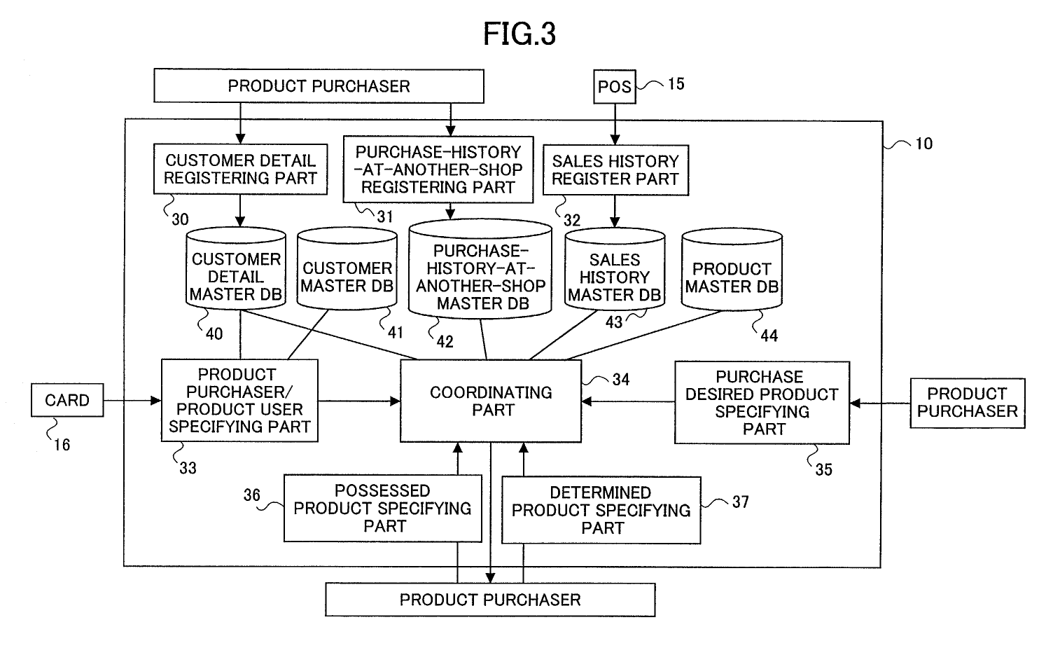

Hereinafter, the process in the product selection supporting server 10 will be mainly described in the system 1 realizing the method for supporting to select products, according to the present invention. FIG. 3 is a diagram showing a function that the product selection supporting server 10 includes.

The product selection supporting server 10 in FIG. 3 includes a customer detail registering part 30, a purchase-history-at-another-shop registering part 31, a sales history registering part 32, a product purchaser/product user specifying part 33, a coordinating part 34, a purchase desired product specifying part 35, a possessed product specifying part 36, a determined product specifying part 37, a customer detail master DB 40, a customer master DB 41, a purchase-history-at-another-shop master DB 42, a sales history master DB 43, and a product master DB 44.

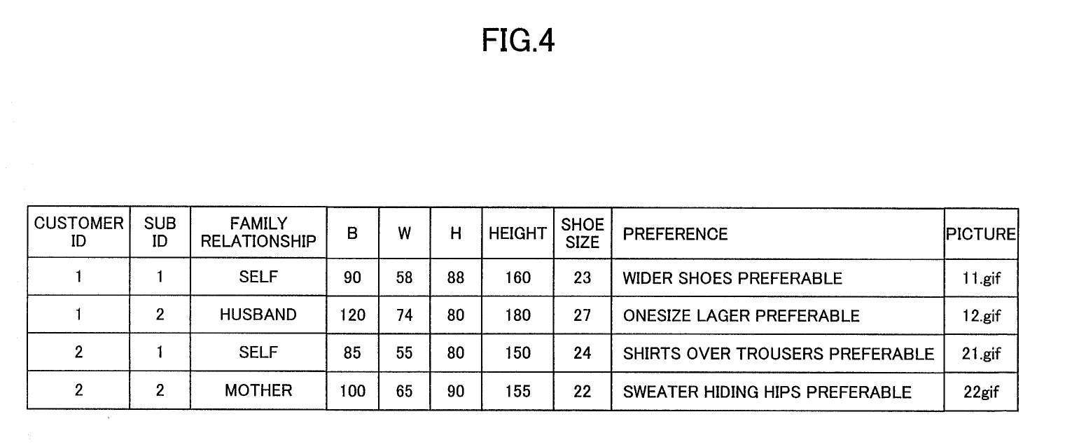

The customer detail registering part 30 registers customer detail information concerning the product purchaser or the product user to the customer detail master DB 40 as shown in FIG. 4. FIG. 4 is a diagram showing a configuration example of the customer detail master DB.

The customer detail master DB 40 includes a customer ID, a sub ID, a family relationship, B, W, H, a height, a shoe size, a preference, a picture, and a like as items. An item “customer ID” and an item “sub ID” indicate identification information of the product purchaser and the product user, respectively. An item “family relationship” indicates a family relationship between the product purchaser and the product user. An item “B”, an item “W”, an item “H”, an item “height”, and item “shoe size” indicate a bust (B) size, a waist (W) size, a hip (H) size, a height, and the shoe size, respectively. An item “preference” indicates a file name of an image picture of a customer.

The customer detail registering part 30 registers the customer detail information to the customer detail master DB 40 in accordance with steps as shown in FIG. 5. FIG. 5 is a flowchart for explaining a process example conducted by the customer detail registering part.

In a step S1, the customer ID read from a card 16 such as a department store card (hereinafter, called card) or the customer ID input from the customer terminals 11a through 11n and the shop terminals 12a through 12m are supplied to the customer detail registering part 30.

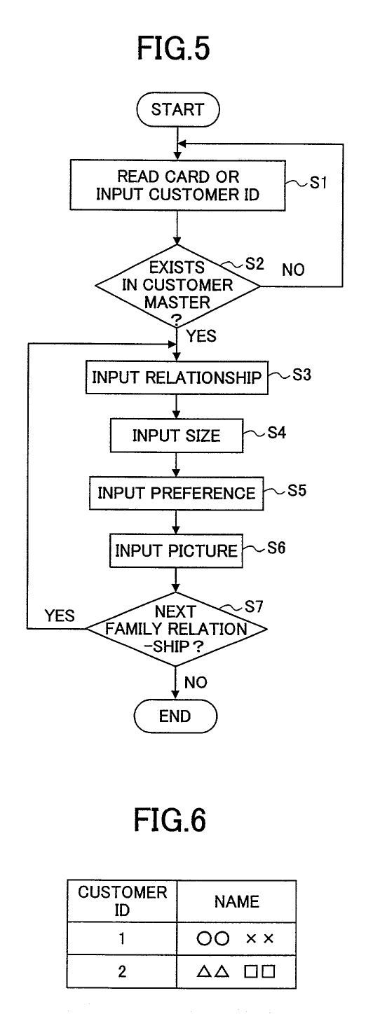

A step S2 is conducted following the step S1. The customer detail registering part 30 determines whether or not the customer ID supplied in the step S1 exists in the customer master DB 42 as shown in FIG. 6.

FIG. 6 is a diagram showing a configuration example of the customer master DB 41. The customer master DB 41 includes the customer ID, a name, and the liked, as items. For example, customer information stored in the customer master DB 41 is registered when the card 16 is created.

When it is determined that the customer ID supplied in the step S1 exists in the customer master DB 41 (YES in the step S2), the customer detail registering part 30 goes to a step S3. On the other hand, when it is determined that the customer ID supplied in the step S1 does not exist in the customer master DB 41 (NO in the step S2), the customer detail registering part 30 goes back to the step S1.

In the step S3, the family relationship input from the customer terminals 11a through 11n and the shop terminals 12a through 12m is supplied to the customer detail registering part 30. The customer detail registering part 30 registers the family relationship and the sub ID to the customer detail master DB 40 corresponding to the customer ID input in the step S1.

A step S4 is conducted following the step S3. The bust size, the waist size, the hip size, the height, and the shoe size, which are input from the customer terminals 11a through 11n or the shop terminals 12a through 12m, are supplied to the customer detail registering part 30. The customer detail registering part 30 registers the bust size, the waist size, the hip size, the height, and the shoe size to the customer detail master DB 40 corresponding to the sub ID registered in the step S3.

A step S5 following step S4 is conducted. The preference input from the customer terminals 11a through 11n or each of the shop terminals 12a through 12m is supplied to the customer detail registering part 30 in a text form. The customer detail registering part 30 registers the preference to the customer detail master DB 40 corresponding to the sub ID registered in the step S3.

A step S6 is conducted following the step S5. A file of the image picture of the customer input from the customer terminals 11a through 11n or each of the shop terminals 12a through 12m is supplied to the customer detail registering part 30. The customer detail registering part 30 registers a file name for the image picture to the customer detail master DB 30 by corresponding to the sub ID.

A step S7 is conducted following the step S6. The customer detail registering part 30 determines whether or not a notification indicating that there is another family relationship is input from the customer terminals 11a through 11n or the shop terminals 12a through 12m. When it is determined that the notification indicating that there is another family relationship is input (YES in the step S7), the customer detail registering part 30 goes back to the step S3. On the other hand, when it is determined that the notification indicating that there is no other family relationship is input (NO in the step S7), the customer detail registering part 30 terminates the process.

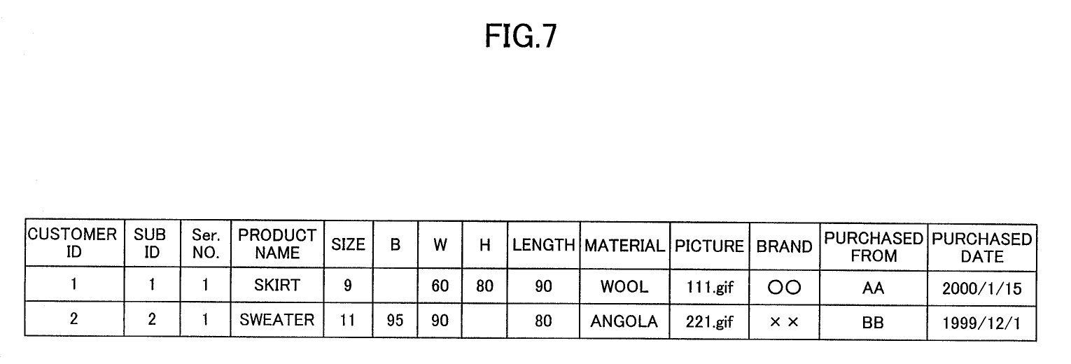

The purchase-history-at-another-shop registering part 31 registers product information concerning a possessed product that the product purchaser or the product user purchases at a shop of another department store (hereinafter, called another shop) to the purchase-history-at-another-shop master DB 42 as shown in FIG. 7.

FIG. 7 is a diagram showing a configuration example of the purchase-history-at-another-shop master DB. The purchase-history-at-another-shop master DB 42 includes the customer ID, the sub ID, a serial number (Ser.No.), a product name, a size, B, W, H, a length, a material, a picture, a brand, a purchase-from, and a purchased date, as items. An item “Ser. No.” indicates a serial number assigned to a possessed product of the product user. An item “product name” indicates the product name of the possessed product. An item “size”, and item “B”, an item “W”, an item “H”, and an item “length” indicate the size of the possessed product.

An item “material” indicates a material of the possessed product. An item “picture” indicates the file name of the image picture of the possessed product. An item “brand” indicates a brand of the possessed product. An item “purchased-from” indicates a shop name where the product user purchased the possessed product. An item “purchased date” indicates a year, a month, and a date when the product user purchased the possessed product.

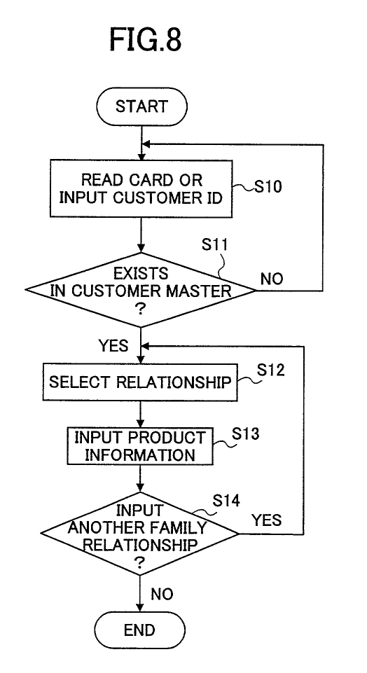

The purchase-history-at-another-shop registering part 31 registers the product information concerning the possessed product purchased at another shop to the purchase-history-at-another-shop master DB 42, in accordance with steps shown in FIG. 8. FIG. 8 is a flowchart for explaining a process example conducted by the purchase-history-at-another-shop registering part 31. In FIG. 8, a process in a step S10 is the same as that in the step S1 and a process in a step S11 is the same as that in the step S2. Thus, explanations thereof are omitted.

In a step S12, the purchase-history-at-another-shop registering part 31 searches for the customer detail master DB 40 by the customer ID input in the step S10 as key information, and obtains the sub ID and the family relationship corresponding to the customer ID. The purchase-history-at-another-shop registering part 31 supplies the sub ID and the family relationship obtained from the customer detail master DB 40 to the customer terminals 11a through 11n or the shop terminals 12a through 12m, and then allows the customer to select the sub ID and the family relationship.

A step S13 is conducted following the step S12. The product information input from the customer terminals 11a through 11n or the shop terminals 12a through 12m is supplied to the purchase-history-at-another-shop registering part 31. The purchase-history-at-another-shop registering part 31 registers the product information to the purchase-history-at-another-shop master DB 42 by corresponding to the customer ID input in the step S10 and the sub ID in the step S12.

A step S14 is conducted following the step S13. The purchase-history-at-another-shop registering part 31 determines whether or not the notification indicating that there is another family relationship is received from the customer terminals 11a through 11n or the shop terminals 12a through 12m. When it is determined that the notification indicating that there is another family relationship is received (YES in the step S14), the purchase-history-at-another-shop registering part 31 goes to the step S12.

On the other hand, when it is determined that the notification indicating that there is no another family relationship received (NO in the step S14), the purchase-history-at-another-shop registering part 31 terminates the process. Accordingly, the product information concerning a product that the customer purchased at another shop is registered in the purchase-history-at-another-shop master DB 42 by the purchase-history-at-another-shop registering part 31.

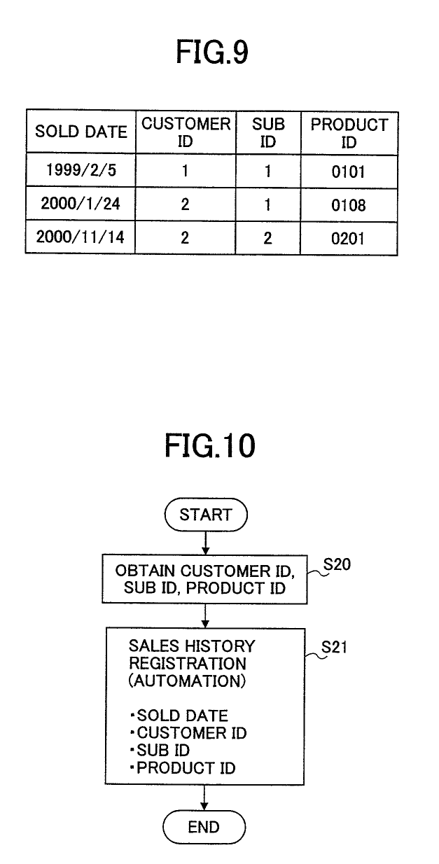

For example, the sales history registering part 32 registers the product information concerning a product that the shop in the department store (hereinafter, called shop) to the sales history master DB 43 as shown in FIG. 9. FIG. 9 is a diagram showing a configuration example of the sales history master DB. The sales history master DB 43 includes a sold date, the customer ID, the sub ID, and the product ID, as items. An item “sold date” indicates a date when the shop sold the product to the product purchaser. An item “product ID” is product identification.

The sales history registering part 32 registers the product information concerning the product sold at the shop to the sales history master DB 43 in accordance with steps shown in FIG. 10. FIG. 10 is a flowchart for explaining a process example conducted by the sales history registering part 32.

In a step S20, the customer ID read from the card 16 or the customer ID input from the customer terminals 11a through 11n or the shop terminals 12a through 12m is supplied to the sales history registering part 32.

The sales history registering part 32 searches for the customer detail master DB 40 by using the customer ID as key information, and obtains the sub ID corresponding to the customer ID. Moreover, for example, the product ID and the sold date of the product that is sold to the product purchaser are supplied from a POS (Point Of Sales system) 15 to the sales history registering part 32. The process goes to a step S21 following the step S20. The sales history registering part 32 registers the sold date, the customer ID, the sub ID, and the product ID to the sales history master DB 43.

Accordingly, the product information concerning the product that the customer purchased at the shop is automatically stored in the sales history master DB 43.

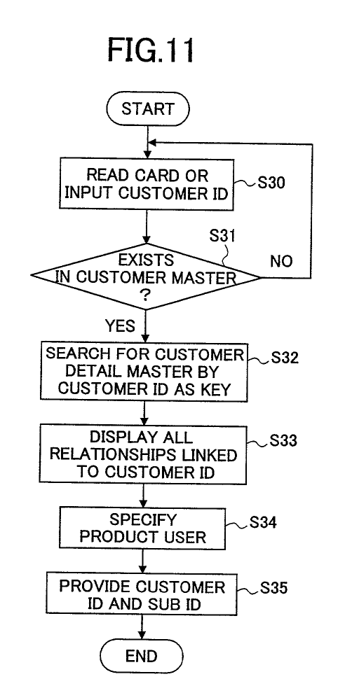

The product purchaser/product user specifying part 33 specifies the product purchaser and the product user in accordance with steps shown in FIG. 11. FIG. 11 is a flowchart for explaining a process example conducted by the product purchaser/product user specifying part 33. In FIG. 11, a process in a step S30 is the same as that in the step S1 and a process in a step S31 is the same as that in the step S2. Thus, explanations thereof are omitted.

In a step S32, the product purchaser/product user specifying part 33 searches for the customer detail master DB 40 by the customer ID input in the step S30 as key information, and obtains the sub ID and the family relationship related to the customer ID. A step S33 is conducted following the step S32. The product purchaser/product user specifying part 33 displays all family relationships related to the customer ID to the customer terminals 11a through 11n or the shop terminals 12a through 12m.

A step S34 is conducted following the step S33. The product purchaser/product user specifying part 33 allows the customer to select one of the family relationships displayed at the customer terminals 11a through 11n or the shop terminals 12a through 11m, and specifies the product user. A step S35 is conducted following the step S34. The product purchaser/product user specifying part 33 provides the customer ID and the sub ID corresponding to the product user specified in the step S34 to the coordinating part 34.

Accordingly, the customer ID and the sub ID corresponding to the product user are provided to the coordinating part 34 by the product purchaser/product user specifying part 33.

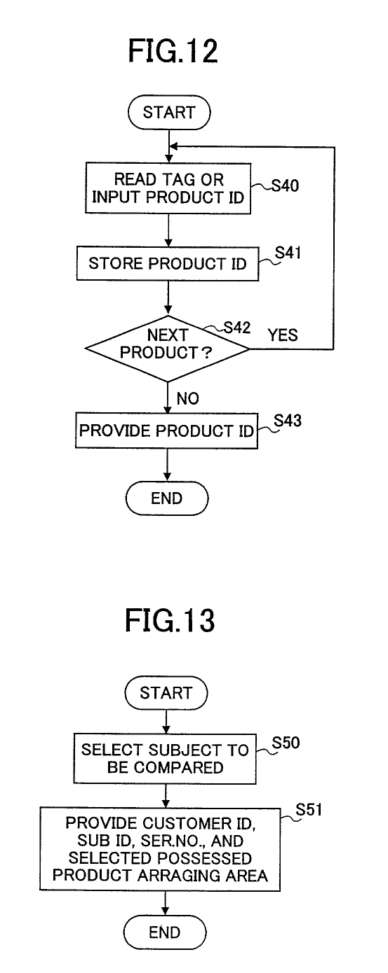

The purchase desired product specifying part 35 specifies the product ID of a purchase desired product that the product purchaser selects in accordance with steps in FIG. 12. FIG. 12 is a flowchart for explaining a process example conducted by the purchase desired product specifying part 35.

In a step S40, the product ID read from a tag (price tag) of the purchase desired product selected by the product purchaser or the product ID input from the shop terminals 12a through 12m is supplied to the purchase desired product specifying part 35. A step S41 is conducted following the step S40. The purchase desired product specifying part 35 stores the product ID supplied in the step S40.

A step S42 is conducted following the step S41. The purchase desired product specifying part 35 determines whether or not a notification indicating that there is another purchase desired product is input from the customer terminals 11a through 11n or the shop terminals 12a through 12m. When it is determined that the notification indicating that there is another purchase desired product is input (YES in the step S42), the purchase desired product specifying part 35 goes back to the step S40.

On the other hand, when it is determined that the notification indicating that there is not another purchase desired product is input (NO in the step S42), the purchase desired product specifying part 35 goes to a step S43. And in the step S43, the purchase desired product specifying part 35 provides the product ID stored in the step S41 to the coordinating part 34 and then terminates the process.

Accordingly, the product ID of the purchase desired product selected by the product purchaser is provided to the coordinating part 34 by the purchase desired product specifying part 35.

The possessed product specifying part 36 specifies the possessed product, which is used to be compared, from the possessed products of the product user, in accordance with steps shown in FIG. 13. FIG. 13 is a flowchart for explaining a process example conducted by the possessed product specifying part.

In a step S50, in response to a request from the customer terminals 11a through 11n or the shop terminals 12a through 12m, the possessed product specifying part 36 selects the possessed product to be compared. The possessed product selected by the possessed product specifying part 36 is arranged in a product comparison area that will be described later.

A step S51 is conducted following the step S50. The possessed product specifying part 36 supplies the customer ID, the sub ID, the serial number, and an area (for example, the product comparison area or the like) including the possessed product selected by the possessed product specifying part 36 to the coordinating part 34. Therefore, the possessed product to be compared is provided to the coordinating part 34 by the possessed product specifying part 36.

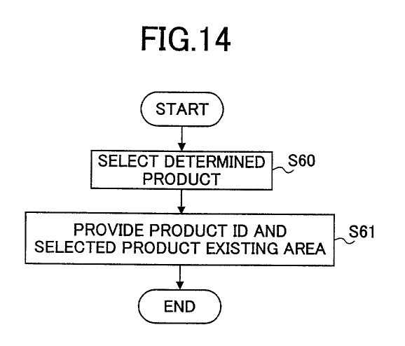

The determined product specifying part 37 specifies the purchase desired product to be determined from the purchase desired products in accordance with steps as shown in FIG. 14. FIG. 14 is a flowchart for explaining a process example conducted by the determined product specifying part.

In a step S60, in response to a request from the customer terminals 11a through 11n or the shop terminals 12a through 12m, the determined product specifying part 37 selects the purchase desired product whose purchase is to be determined. The purchase desired product selected by the determined product specifying part 37 is positioned in the product comparison area or a product user comparison area that will be described later.

A step S61 is conducted following the step S60. The determined product specifying part 37 provides the product ID, an area arranging the purchase desired product (for example, the product comparison area, the product user comparison area, or the like) to the coordinating part 34, and then terminates the process. Accordingly, the purchase desired product whose purchase is to be determined is provided to the coordinating part 34 by the determined product specifying part 37.

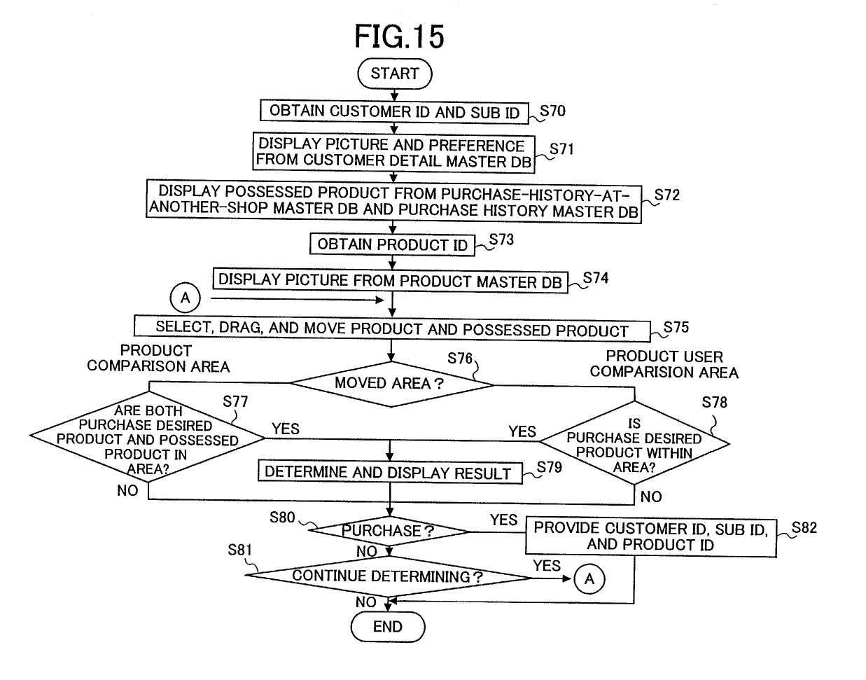

The coordinating part 34 compares the possessed product or the purchase desired product with information of the product user and makes a purchasing determination based on a comparison result, in accordance with steps in FIG. 15. FIG. 15 is a flowchart for explaining a process example conducted by the coordinating part.

In a step S70, the customer ID and the sub ID specified by the product purchaser/product user specifying part 33 is supplied to the coordinating part 34. The process goes to a step S71 following the step S70. The coordinating part 34 searches for the customer detail master DB 40 by the customer ID and the sub ID supplied in the step S70, and obtains the information of the product user corresponding to the customer ID and the sub ID (for example, the bust size, the waist size, the hip size, the height, the shoe size, the preference, the file name of the image picture of the product user).

The coordinating part 34 displays the information of the product user to the customer terminals 11a through 11n or the shop terminals 12a through 12m. A step S72 is conducted following the step S71. The coordinating part 34 searches for the purchase-history-at-another-shop master DB 42 and the sales history master DB 43 by the customer ID and the sub ID supplied in the step S70, and obtains the product information concerning the possessed product of the product user. The coordinating part 34 displays the product information concerning the possessed product of the product user to the customer terminals 11a through 11n or the shop terminals 12a through 12m.

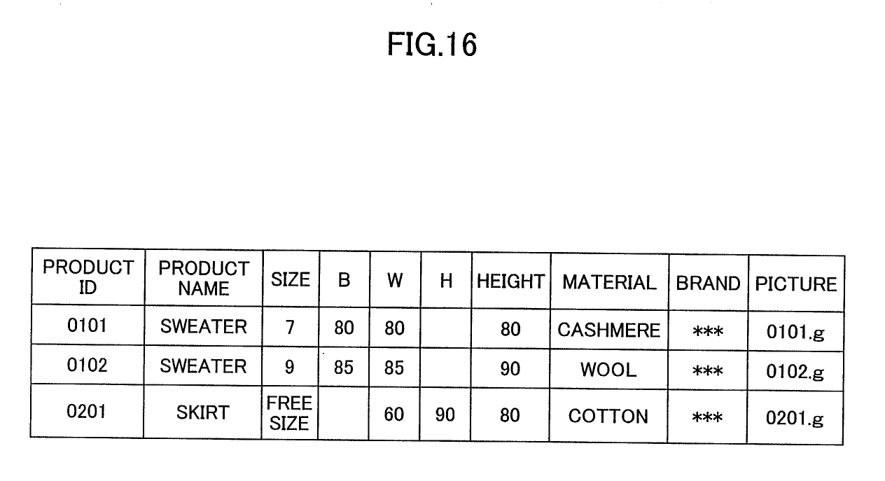

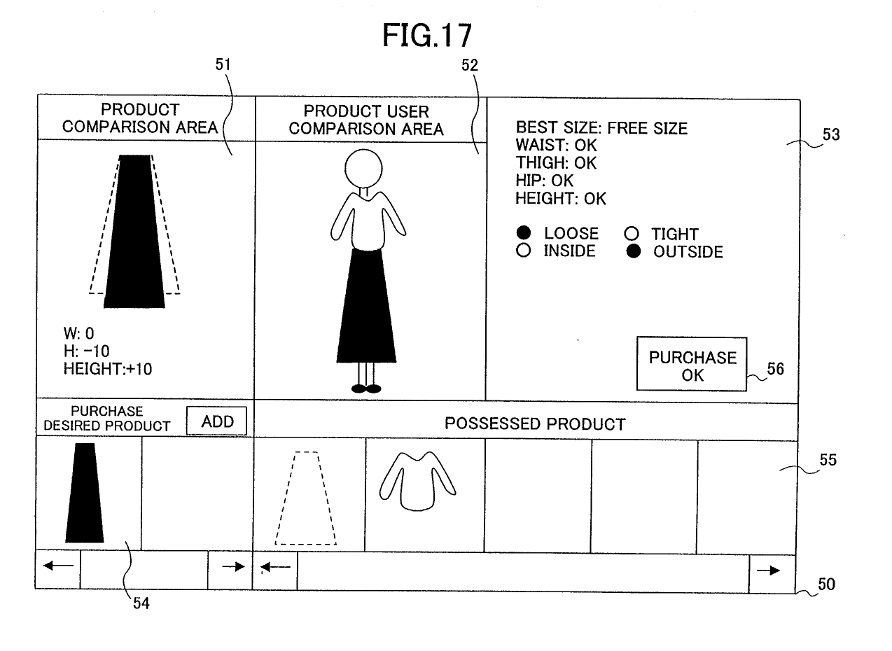

A step S73 is conducted following the step S72. The product ID of the purchase desired product that the product purchaser selected is supplied to the coordinating part 34 from the purchase desired product specifying part 35. A step S74 is conducted following the step S73. The coordinating part 34 searches the product master DB 44 as shown in FIG. 16 by the product ID supplied in the step S73, and obtains the image picture of the product corresponding to the product ID.

FIG. 16 is a diagram showing a configuration example of the product master DB. The product master DB 44 includes the product ID, the product name, the size, B, W, H, the height, the material, the brand, the picture, and the like, as items. An item “picture” indicates the file name of the image picture of the product. In the image picture, each of products is digitized in the same-scaled image. By overlapping image pictures using the output unit or the like, it is possible to compare the sizes of the products corresponding to the image pictures with each other.

For example, the coordinating part 34 reads the file of the image picture based on the file name of the image picture from the storage unit 25, and displays the image picture at the customer terminals 11a through 11n or the shop terminals 12a through 12m.

For example, the coordinating part 34 displays the product selection supporting window as shown in FIG. 17 by steps S71 through S74 at the customer terminals 11a through 11n or the shop terminals 12a through 12m. FIG. 17 is a diagram showing an example of the product selection supporting window.

The product selection supporting window 50 in FIG. 17 includes a product comparison area 51, a product user comparison area 52, a determination/result display area 53, a purchase desired product display area 54, and a possessed product display area 55.

The product comparison area 51 shows an area for comparing the image picture of the purchase desired product with the image picture of the possessed product. By overlapping and displaying a plurality of the image pictures with each other, it is possible to compare the size of the purchase desired product with the size of the possessed product. In this case, a method for displaying image pictures in transparent or semitransparent may be applied to overlap the plurality of image pictures.

The product user comparison area 52 shows an area for comparing the size of the purchase desired product with the size of the product user. The determination/result display area 53 shows a result from comparing in the product comparison area 51 or the product user comparison area 52, or a result from determining based a comparison result.

For example, in a case in which the comparison result is displayed in the determination/result display area 53, a difference between the size of the purchase desired product and the size of the possessed product is displayed. Moreover, in a case in which a determination result based on the comparison result is displayed in the determination/result display area 53, a determination condition master table (not shown) is prepared beforehand. For example, the determination condition master table defines “OK”, “NG”, “LOOSE”, “TIGHT”, and the like as the determination result corresponding to the difference between the size of the purchase desired product and the size of the possessed product. The determination/result display area 53 displays the determination result based on the comparison result and the determination condition master table.

The purchase desired product display area 54 shows the purchase desired product of the product purchaser. The possessed product display area 55 shows the possessed product of the product user.

A step S75 is conducted following the step S74. In response to a request from the customer terminals 11a through 11n or the shop terminals 12a through 12m, the coordinating part 34 moves image information of the purchase desired product from the purchase desired product display area 54 to the product comparison area 51 or the product user comparison area 52. Or, in response to a request from the customer terminals 11a through 11n or the shop terminals 12a through 12m, the coordinating part 34 moves image information of the possessed product from the product display area 55 to the product comparison area 51 or the product user comparison area 52.

A step S76 is conducted following the step S75. The coordinating part 34 determines to which one of the product comparison area 51 and the product user comparison area 52 the purchase desired product and the possessed product are moved.

When it is determined that the purchase desired product and the possessed product are located in the product comparison area 51 (PRODUCT COMPARISON AREA in the step S76), the coordinating part 34 goes to a step S77. Moreover, when it is determined that the purchase desired product and the possessed product are arranged in the product user comparison area 52 (PRODUCT USER COMPARISON AREA in the step S76), the coordinating part 34 goes to a step S78.

In the step S77, the coordinating part 34 determines whether or not the purchase desired product and the possessed product are in the product comparison area 51. When it is determined that the purchase desired product and the possessed product are in the product comparison area 51 (YES in the step S77), the coordinating part 34 goes to a step S79. On the other hand, when it is determined that the purchase desired product or the possessed product is not in the product comparison area 51 (NO in the step S77), the coordinating part 34 goes to a step S80.

In the step S78, the coordinating part 34 determines whether or not the purchase desired product is in the purchaser user comparison area 52. Alternatively, in the step S78, the coordinating part 34 determines whether or not the purchase desired product and the possessed product are in the product user comparison area 52. When it is determined that the purchase desired product is in the product user comparison area 52 (YES in the step S78), the coordinating part 34 goes to a step S79. On the other hand, when it is determined that the purchase desired product is not in the product user comparison area 52 (NO in the step S78), the coordinating part 34 goes to the step S80.

In the step S79, the coordinating part 34 displays the comparison result from comparing the purchase desired product with the possessed product that are arranged in the product comparison area 52, or the determination result based on the comparison result, in the determination/result display area 53. In addition, the coordinating part 34 displays the comparison result from comparing the purchase desired product arranged in the product user comparison area 52 with the information of the product user, or the determination result based on the comparison result, in the determination/result display area 53. When a process in the step S79 is completed, the coordinating part 34 goes to the step S80.

In the step S80, the coordinating part 34 determines whether or not a request to purchase the product is sent from the customer terminals 11a through 11n or the shop terminals 12a through 12m. For example, the product purchaser can send the request to purchase the product by clicking a purchase OK button 56 in the determination/result display area 53.

When the request to purchase the product is sent from the product purchaser (YES in the step S80), the coordinating part 34 goes to a step S82. In the step S82, the coordinating part 34 provides the customer ID, the sub ID, and the product ID to the sales history registering part 32, and terminates the process.

On the other hand, when the request to purchase the product is not sent from the product purchaser (NO in the step S80), the coordinating part 34 goes to the step S81. In the step S81, the coordinating part 34 determines whether or not a request to continue processing in the product selection supporting window 50 is sent from the customer terminals 11a through 11n or the shop terminals 12a through 12m.

When the request to continue processing in the product selection supporting window 50 is sent (YES in the step S81), the coordinating part 34 goes to the step S75. On the other hand, when the request to continue processing in the product selection supporting window 50 is not sent (NO in the step S81), the coordinating part 34 terminates the process.

Therefore, the coordinating part 34 can compare the possessed product or the purchased desired product with the information of the product user, and can make a determination based on the comparison result.

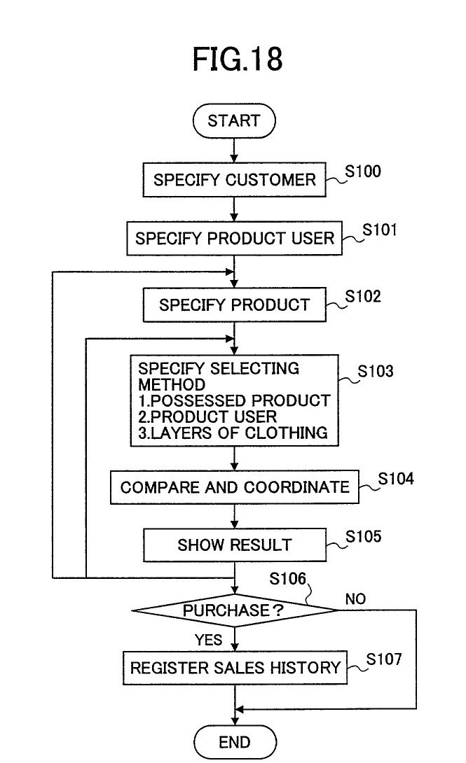

A process until the customer selects the purchase desired product at the shop and purchases the purchase desired product will be described with reference to a flowchart in FIG. 18. FIG. 18 is a flowchart for explaining an example of a method for supporting to select products, according to the embodiment of the present invention.

In a step S100, the customer ID is read from the card 16 of the customer who comes to purchase the product at the shop, the product purchaser is specified by the product purchaser/product user specifying part 33 and the customer master DB 41. Alternatively, the customer ID may be input at the shop terminals 12a through 12m, and the product purchaser may be specified by the product purchaser/product user specifying part 33 and the customer master DB 41.

A step S101 is conducted following the step S100. The product purchaser/product user specifying part 33 reads the family relationships corresponding to the customer ID from the customer detail master DB 40, and provides all family relationships to display at the shop terminals 12a through 12m. At the shop, one family relationship is selected from at least one family relationship displayed at the shop terminals 12a through 12m so as to specify the product user. That is, one record is specified from the customer detail master DB 40.

Moreover, by specifying the product user, the product information concerning the possessed product can be read from the purchase-history-at-another-shop master DB 42 and the sales history master DB 43. For example, the image picture of the possessed product is displayed in the possessed product display area 55 of the product selection supporting window 50 by using the product information concerning the possessed product read from the purchase-history-at-another-shop master DB 42 and the sales history master DB 43.

A step S102 is conducted following the step S101. For example, at the shop, the product ID of the purchase desired product selected by the product purchaser is read by using the POS 15 in FIG. 3 and the purchase desired product is specified. That is, one record is specified from the product master DB 44.

Therefore, the product information concerning the purchase desired product is read from the product master DB 44. By using the product information concerning the purchase desired product read from the product master DB 44, for example, the image picture of the purchase desired product is displayed in the purchase desired product display area 54 of the product selection supporting window 50.

A step S103 is conducted following the step S102. The product purchaser specifies a selection method that is conducted on the product selection supporting window 50. As the selection method that is conducted in the product selection supporting window 50, there is a method to compare the size of the purchase desired product with the size of the possessed product, a method to compare the size of the purchase desired product with the size of the product user, and a method to compare the purchase desired product with the possessed product by overlapping or combining them.

For example, in order to select the method to compare the size of the purchase desired product with the size of the possessed product, the purchase desired product is moved from the purchase desired product display area 54 to the product comparison area 51, and also the possessed product is moved from the product display area 55 to the product comparison area 51.

In order to select the method to compare the size of the purchase desired product with the size of the product user, the purchase desired product is moved from the purchase desired product display area 54 to the product user comparison area 52.

In order to select the method to compare the purchase desired product with the possessed product by overlapping or combining them, the purchase desired product is moved from the purchase desired product display area 54 to the product user comparison area 52 by taking into account the overlapping order, and also the possessed product is moved from the possessed product display area 55 to the product user comparison area 52.

A step S104 is conducted following the step S103. The coordinating part 34 conducts a comparing/coordinating process in accordance with the selection method.

For example, when the method to compare the size of the purchase desired product with the size of the possessed product is selected as the selection method, the coordinating part 34 compares the size of the purchase desired product with the size of the possessed product, which are arranged in the product comparison area 51.

When the method to compare the size of the purchase desired product with the size of the product user is selected, the coordinating part 34 compares the size of the purchase desired product with the size of the product user, which are arranged in the product user comparison area 52.

When the method to compare the purchase desired product with the possessed product by overlapping or combining them is selected, it is assumed that the product purchaser wears the purchase desired product or the possessed product, and then a thickness, a fitness, a color tone, and a like are compared.

A step S105 is conducted following the step S104. The coordinating part 34 displays a comparison result in the step S105 or a determination result based on the comparison result in the determination/result display area 53. Therefore, the product purchaser can visually or numerically select the purchase desired product suitable for the product user on the product selection supporting window 50.

For example, in the product comparison area 51 of the product selection supporting window 50 in FIG. 17, since the possessed product is depicted by a dotted line, it is possible to visually compare the size of the purchase desired product with the size of the possessed product. Alternatively, indicating the comparison result of the size of the purchase desired product and the size of the possessed product by numeral values in the product comparison area 51 assists the visual comparison of the sizes thereof.

Moreover, in the product user comparison area 52 of the product selection supporting window 50, a body form of the product user is displayed and an image of virtually trying on the purchase desired product or the possessed product moved from the purchase desired product display area 54 or the possessed product display area 55 is displayed. Therefore, it is possible to easily compare the size of the purchase desired product with the size of the product user visually.

Furthermore, for example, the determination/result display area 53 displays a result from deducting the size of the possessed product from the size of the purchase desired product, as the comparison result. In addition, the determination result based on the comparison result can be displayed in the determination/result display area 53.

For example, in a case in which a result from deducting the size of the possessed product from the size of the purchase desired product is 4 cm, “waist size +4 cm” may be displayed in the determination/result display area 53. Moreover, if “OK” is set as a determination condition when the comparison result of the waist size shows “0 to 5 cm”, and “NG” is set as the determination condition when the comparison result of the waist size shows “except 0 to 5 cm”, the determination result based on the comparison result can be displayed in the determination/result display area 53.

When the step S105 is completed, the step S102 or the step S103 is conducted in response to an instruction from the product purchaser. The instruction from the product purchaser is supplied from the shop terminals 12a through 12m.

A step S106 is conducted following the step S105. The coordinating part 34 determines whether or not a request of purchasing the product is sent from the shop terminals 12a through 12m.

When it is determined that the request of purchasing the product is made by the product purchaser (YES in S106), the coordinating part 34 provides the customer ID, the sub ID, and the product ID to the sales history registering part 32, and goes to a step S107. In the step S107, the sales history registering part 32 registers the customer ID, the sub ID, the product ID, and the like to the sales history master DB 43.

When it is determined that the request of purchasing the product is not made by the product purchaser (NO in the step S106), the coordinating part 34 completes the process. Accordingly, the shop can automatically register the product information concerning the product that is sold to the product purchaser to the sales history master DB 43.

Moreover, since the shop can analyze information automatically registered to the purchase-history-at-another-shop master DB 42 or the sales history master DB 43, it is possible for the shop to know when and for whom the product purchaser purchased the product and to know the preference of the product user. Therefore, it is possible to conduct better sales promotions, to improve customer satisfaction, and to obtain more repeat customers.

As described above, according to the present invention, since a result from comparing image information of the purchase desired product with image information of the possessed product or another purchase desired product is shown to the product purchaser, it is possible for the product purchaser to select a product suitable for the product user.

Moreover, according to the present invention, since the product user or the product purchaser can intuitively and easily imagine the possessed product possessed by the product user, it is possible for the product purchaser to comfortably select the product suitable to the product user by referring to the result from comparing the image information of the possessed product with the image information of the purchase desired product.

Furthermore, according to the present invention, since the image information of the possessed product is utilized, it is possible for the product purchaser to select the product suitable to the product user while considering a combination of the possessed product and the purchase desired product.

The present invention is not limited to the specifically disclosed embodiments, variations and modifications, and other variations and modifications may be made without departing from the scope of the present invention.

The present application is based on Japanese Priority Application No.2001-244841 filed on Aug. 10, 2001, the entire contents of which are hereby incorporated by reference.

What is claimed is:

1. A method for supporting to select products suitable to a product user by using a computer, comprising the steps of:
(a) obtaining first image information of a possessed product possessed by the product user;
(b) obtaining second image information of a purchase desired product desired for purchase by a product purchaser; and
(c) showing a result from comparing the first image information with the second image information, to the product purchaser.

2. The method as claimed in claim 1, wherein said step (a) comprises the steps of:
(d) specifying the product user; and
(e) reading said first image information of the possessed product corresponding to the product user specified in said step (d) from a possessed product information storing part storing said first image information of the possessed product possessed by at least one product user.

3. The method as claimed in claim 2, wherein said first image information of the possessed product is stored in the possessed product information storing part corresponding to the product user when the possessed product is sold.

4. The method as claimed in claim 2, wherein said first image information of the possessed product is stored in the possessed product information storing part from a terminal used by the product user or the product purchaser via a network.

5. The method as claimed in claim 1, wherein said first image information obtained in said step (a) and said second image information obtained in said step (b) are digitized in the same-scaled images so that a size of the possessed product and a size of the purchase desired product are comparable to each other.

6. The method as claimed in claim 1, wherein said step (c) comprises the steps of:
(f) comparing said second image information of the purchase desired product with said first image information of the possessed product or image information of another purchase desired product different from said second image information of said purchase desired product by overlapping said second image information with said first image information or the image information of the other purchase desired product other than said second image information; and
(g) providing a comparison result in said step (f) to the product purchaser.

7. The method as claimed in claim 1, further comprising the step of combining at least one first image information of the possessed product with at least one second image information of the purchase desired product.

8. The method as claimed in claim 1, wherein said product user and the product purchaser are the same person.

9. A server for supporting to select products suitable to a product user, comprising:
a first obtaining part obtaining first image information of a possessed product possessed by the product user;
a second obtaining part obtaining second image information of a purchase desired product desired for purchase by a product purchaser; and
a result providing part showing a result from comparing the first image information with the second image information, to the product purchaser.

10. The server as claimed in claim 9, wherein said first obtaining part comprises:
a specifying part specifying the product user; and
a reading part reading said first image information of the possessed product corresponding the product user specified in said specifying part from a possessed product information storing part storing said first image information of the possessed product possessed by at least one product user.

11. A computer-readable recording medium having a program recorded thereon for causing a computer to support to select products, comprising:
(a) obtaining first image information of a possessed product possessed by a product user;
(b) obtaining second image information of a purchase desired product desired for purchase by a product purchaser; and
(c) showing a result from comparing the first image information with the second image information, to the product purchaser.
